(19) United States
(12) Patent Application Publication
(10) Pub. No.: US 2013/0156528 A1
(43) Pub. Date: Jun. 20, 2013

(54) METHOD FOR PROCESSING PRESS SHEETS FOR PRINTED PRODUCTS

(71) Applicant: Peter Schmidkonz, Nittenau (DE)

(72) Inventor: Peter Schmidkonz, Nittenau (DE)

(21) Appl. No.: 13/719,290

(22) Filed: Dec. 19, 2012

(30) Foreign Application Priority Data
Dec. 19, 2011 (DE) 102011056612.0

(51) Int. Cl. B42C 11/00

(52) U.S. Cl. CPC B42C 11/00
USPC 412/4

(57) ABSTRACT

Press sheets and methods for processing press sheets to produce book blocks are disclosed wherein double slot perforation lines each comprising one first and second perforation line having slots respectively of the same slot length are produced on a press sheet. The slots of the first and second perforation line are produced in such a manner that two consecutive slots of one perforation line have a distance of one slot length from each other, that the first and second perforation line are arranged so that the first and second perforation line extend parallel and in spaced relation to each other and have a longitudinal offset of one slot length to each other, so that the slots of the first perforation line are arranged respectively staggered to the slots of the second perforation line and that a folding line is formed between the first and second perforation line.

### CROSS-REFERENCE TO RELATED APPLICATIONS

This application claims priority from German Application No. DE 10 2011 056 612.0 filed Dec. 19, 2011, the contents of which are incorporated herein by this reference.

### BACKGROUND OF THE INVENTION

The invention relates to a method for processing press sheets for printed products, in particular book blocks.

Generic methods for processing sheets for printed products are known in the prior art. In particular, WO 2005/023555 A2 discloses an adhesive binding method and a corresponding device for executing this method, in which the press sheets to be bound for producing an adhesive binding are perforated on the fold edge, then folded and then assembled to form a book block. The perforation process is executed on the fold edge in such a manner that an interrupted perforation line forming a widened fold edge is punched in the form of a double slot perforation line. The double slot perforation line comprises one first and one second perforation line, respectively having slots of the same slot length, the slots of the first and second perforation line being produced in a press sheet in the manner that two consecutive slots of one perforation line have a distance of one slot length to each other. Further, the first and second perforation line extend parallel and at a distance from each other and have a longitudinal offset of one slot length to each other, so that the slots of the first perforation line are arranged respectively staggered to the slots of the second perforation line and a folding line is formed between the first and second perforation line. After folding, the fold sheets that result are assembled to form a block and are glued on the edge.

Folding the press sheets along the folding line of the double slot perforation line produces a double sheet comprising two mutually linked sheet sections, which are connected at least partially with each other on the folding line extending in the area of the fold edge. The slot-shaped perforation of the press sheet in the area of the folding line causes tab-shaped protrusions to protrude from the fold edge, preferably directly adjoining each other. Upon folding, these protrusions produced by the slot perforation leave open spaces in the sheet section area directly adjoining the fold edge. The open spaces of the respective sheet sections are at a distance to each other by one slot length, namely by one non-open area lying between two consecutive open spaces. The open spaces of the two connected sheet sections have a longitudinal offset of one slot length. If a plurality of such fold sheets are coated with glue in the folding area and arranged on top of each other so that the fold edges of the fold sheets are congruently superposed, the glue can penetrate the open spaces and the glue adheres between the tab-shaped protrusions and bonds them together. This causes the glue to penetrate deeply into the fold area. In addition, one open space respectively adjoins two sheet sections that have no open spaces at this position. This means that the open spaces of one sheet section connect two sheet sections not directly adjoining each other, namely by means of an adhesive bond through the open space of one sheet section. The same applies to the tab-shaped protrusions. Their position likewise alternates from one sheet section to another, so that the tab-shaped protrusions of each second sheet section correspond to the superposed fold sheets at the same positions respectively. The glue applied to the tab-shaped protrusions therefore respectively bonds one sheet section with the respective second following sheet section. The result of the prior art adhesive bond is an extremely stable and durable adhesive bond for printed products, in particular book blocks.

The disadvantage, however, is that in the case of books to be produced in small quantities and/or in small formats, in particular photo books, substantial processing and handling of the single press sheets is necessary, since each single sheet must be provided with the double slot perforation line and then folded. This makes the prior art method time-consuming and cost-intensive.

The object of the present invention is to improve the prior art method in order to enable more efficient and therefore more cost-effective production of book blocks, in particular in small quantities and/or in small formats.

### SUMMARY OF THE INVENTION

One aspect of the present invention is that at least one first double slot perforation line is produced comprising one first folding line extending in a lengthwise direction of the press sheet is produced and at least one second perforation line comprising a second folding line extending in a crosswise direction of the press sheet is produced and that the alignment of the first and second double slot perforation line in relation to each other is such that the folding line of the one double slot perforation line extends between the slot end of one first slot of the first perforation line and the slot beginning of the second slot of the second perforation line of the second double slot perforation line which (second slot) directly follows the first slot. Such an arrangement of the intersecting double slot perforation lines ensures that the alternation of the slots takes place in the area of the folding line. In case of two perpendicularly intersecting double slot perforation lines it is also ensured that both the openings and the tab-shaped protrusions of one sheet section are offset against the openings and tab-shaped protrusions of the directly adjoining other sheet section preferably by one slot length. By means of one press sheet it is therefore possible to produce a plurality of sheet sections, which have the advantageous properties for creating the high strength adhesive bond, each sheet section forming one page of the book block to be produced.

In a preferred exemplary embodiment the first and second double slot perforation line are arranged in relation to each other so that the point of intersection of the first and second folding line lies respectively on the connecting line between the slot end of one first slot of the first perforation line and the slot beginning of the second slot of the second perforation line which (second slot) directly follows the first slot. This defines both the alignment of the first double slot perforation line to the second folding line and the alignment of the second double slot perforation line to the first folding line so that the first and second folding line respectively extend through the area in which the alternation of the slots is provided. Therefore, the meandering structure both of the first and the second double slot perforation line is completely retained, so that, even in the case of multiple folding of the press sheet on two perpendicularly intersecting double slot perforation lines it is ensured that the open spaces and the tab-shaped protrusions of two consecutive sheet sections have a longitudinal offset of one slot length.

Especially advantageously the distance of the two perforation lines of one double slot perforation line is chosen based on the mass-area ratio of the paper sheet to be processed. For example, this is between 0.3 and 0.4 mm at a paper thickness of 170 g/m2. The slot length is advantageously between 2 and 5 mm. Such dimensioning of the distance of the two perforation lines to the slot length advantageously results in double slot perforation lines that when folded along the folding line enable an optimal design of the tab-shaped protrusions and open spaces.

In particular, a rectangular press sheet is used, the press sheet being divided by the double slot perforation lines into a plurality of rectangular or square sheet sections. The double slot perforation lines therefore enable the production of a plurality of sheets of a book block from one press sheet, the sheet sections respectively having essentially the desired format of the sheets of the book block—with the exception of the edge trim and any non-printable margin areas. This enables improved utilization of the press sheet, i.e. the non-usable area of the press sheet is substantially reduced.

In a preferred exemplary embodiment a plurality of parallel first double slot perforation lines extending in a lengthwise direction of the press sheet and/or a plurality of parallel second double slot perforation lines extending in a crosswise direction of the press sheet are produced. The press sheet can be folded on these parallel double slot perforation lines, in particular it can be folded multiple times alternating in different folding directions, so that a zig-zag fold sheet is produced. This makes it possible to produce a plurality of pages of a book block easily and cost-effectively from one press sheet.

Preferably two consecutive double slot perforation lines have the same distance between each other, respectively. The distance between two consecutive first double slot perforation lines can be chosen to be different from the distance between two consecutive second double slot perforation lines, in order to produce rectangular sheet formats. In particular the distance of two consecutive first double slot perforation lines in relation to the distance of two consecutive second double slot perforation lines can have a ratio of 2/3.

In an especially advantageous embodiment, a plurality of fold sheets are arranged on top of each other so that the fold edges arranged respectively on the edge are superposed and the fold sheets are glued together in a folding area in which a plurality of fold edges are congruently superposed. Depending on the format of the fold sheet or of the desired book block format, either a plurality of book blocks arranged next to each other in a row on the fold sheet is produced simultaneously, or the fold sheet already corresponds essentially to the desired format of the book block—with the exception of the edge trim and any non-printable margin areas. This allows more efficient production of the book blocks.

For the case that a fold sheet is produced having one first edge length that corresponds at least essentially—with the exception of the edge trim and any non-printable margin areas—to one first edge length of the printed product to be produced and the second edge length of the fold sheet is a multiple of the second edge length of the book block to be produced, the book blocks produced simultaneously can have different contents. In this case the press sheet is printed for example in such a manner that the desired contents are provided in different rows or columns, so that after the zig-zag folding and the separation or the edge trim, the pages of the book block comprise the desired contents, the contents of the single book blocks being different. This can be used to achieve efficient production of small quantities, for example of photo books, etc.

In a further exemplary embodiment the fold sheet is folded after at least one first folding on at least one further double slot perforation line extending perpendicular to the fold edge, so that a multiple fold sheet is produced. This multiple fold sheet—again with the exception of the edge trim and any non-printable margin areas—has the format of the desired printed product, in particular a book block. This makes it possible to easily and cost-effectively produce especially book blocks with a small number of pages.

After the multiple fold sheet is produced it is glued in a folding area in which a plurality of fold edges on the edge are aligned on top of each other and the at least one additional fold edge extending perpendicular to the folding area is separated by side cutting. Preferably all other pages are cut by means of side cutting in order to separate the single sheet sections into single sheets.

Especially preferably, all double slot perforation lines are arranged in relation to a corner point of the press sheet or in relation to a corner point of the printable area of the press sheet. This ensures, despite fluctuations in the paper format, that all double slot perforation lines always have the desired distance from the point of reference and therefore also the desired distance to each other.

Further preferably, a press sheet is used that is printed on the front and back and the sheet sections separated from each other by the double slot perforation lines respectively constitute pages of the printed product.

According to a further idea of the invention, a plurality of double slot perforation lines extending parallel and at a distance to each other are produced, the parallel double slot perforation lines being arranged not offset to each other, so that the mutually corresponding slots are arranged at the same height on the press sheet. The mutually parallel double slot perforation lines therefore extend in phase to each other. In the production of a zig-zag fold sheet this achieves that the open spaces and the tab-shaped protrusions created by folding on the respective double slot perforation lines of two consecutive sheet sections respectively have a longitudinal offset of one slot length, so that from one sheet section to the next an alternating offset of the open spaces and tab-shaped protrusions created during folding and therefore bonding respectively of one sheet section with the respective second following sheet sections is achieved.

The method according to the invention also enables substantially improved utilization of the paper formats when printing using digital technology. In particular, multiple folds can be produced and therefore one large-format press sheet, for example in DIN A3++ format can be used to produce the formats DIN A4, DIN A5 through DIN A8.

Especially advantageously this results in a method for automatic one-off production of individual, personalized books.

The term “essentially” or “approximately” as used in the invention means deviations from the exact value by +/−10%, preferably by +/−5% and/or deviations in the form of changes that are insignificant for the function.

The invention is described below in more detail based on exemplary embodiments with reference to the drawings. Further embodiments, advantages and applications of the invention are also disclosed in the following description of the exemplary embodiments and the drawings. All characteristics described and/or pictorially represented, alone or in any combination, are subject matter of the invention, regardless of their being summarized or referenced in the claims. The content of the claims is also included as part of the description.

However, it is expressly noted that the invention is by no means limited to the exemplary embodiments provided.

### BRIEF DESCRIPTION OF THE DRAWINGS

The invention is illustrated in the drawings, where:

FIG. 1 shows a press sheet comprising a plurality of double slot perforation lines produced therein;

FIG. 2 shows the arrangement of two perpendicularly intersecting double slot perforation lines in one first exemplary embodiment;

FIG. 3 shows the arrangement of two perpendicularly intersecting double slot perforation lines in one second exemplary embodiment;

FIG. 4 shows the arrangement of a plurality of fold sheets in perspective view;

FIG. 5 shows a zig-zag fold sheet produced from a press sheet according to FIG. 1, in top view;

FIG. 6 shows zig-zag fold sheet produced from a press sheet according to FIG. 1, in side view;

FIG. 7 shows the process of folding a fold sheet according to FIGS. 4 and/or 5 to form a multiple fold sheet, in a schematic representation;

FIG. 8 shows a multiple fold sheet in top view;

FIG. 9 shows the division of a press sheet into two equally sized sheet sections by means of a double slot perforation line;

FIG. 10 shows the division of a press sheet into four equally sized sheet sections by means of perpendicularly intersecting double slot perforation lines;

FIG. 11 shows the division of a press sheet into six equally sized sheet sections by means of perpendicularly intersecting double slot perforation lines;

FIG. 12 shows the division of a press sheet into eight equally sized sheet sections by means of perpendicularly intersecting double slot perforation lines;

FIG. 13 shows the division of a press sheet into 16 equally sized sheet sections by means of perpendicularly intersecting double slot perforation lines;

FIG. 14 shows the division of a press sheet into 24 equally sized sheet sections by means of perpendicularly intersecting double slot perforation lines.

### DETAILED DESCRIPTION OF THE INVENTION

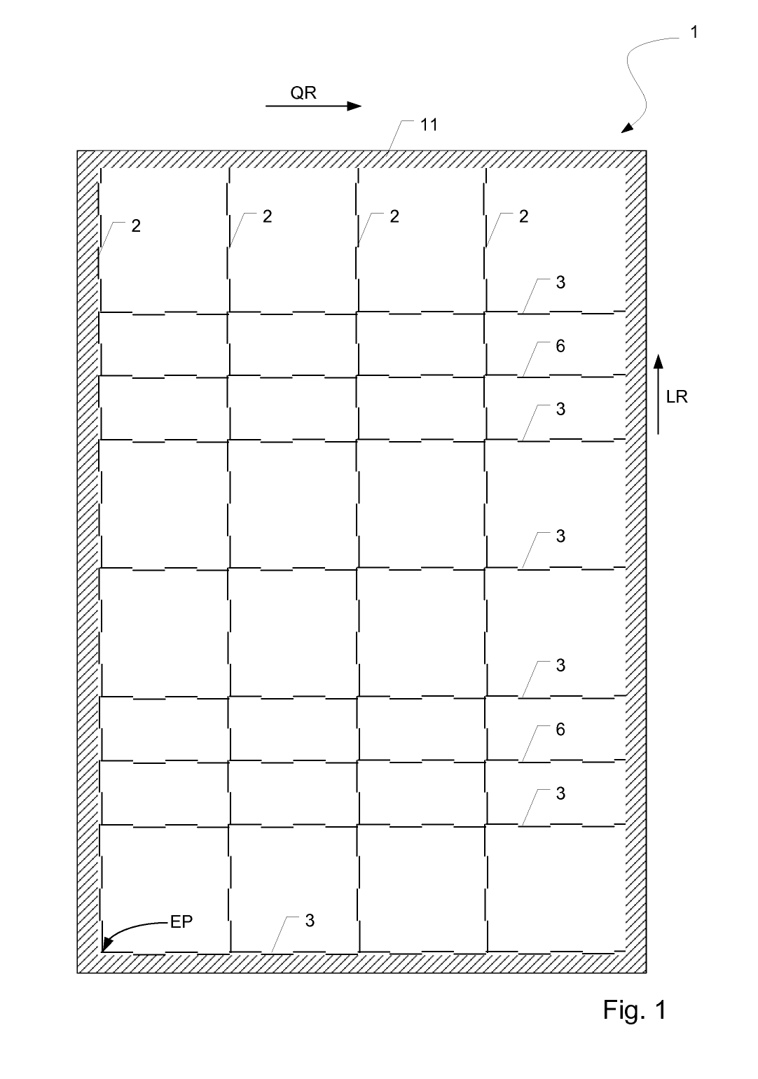

In FIG. 1, reference number 1 designates a press sheet, which is in particular a rectangular paper sheet and is printed on both sides for example by means of a digital printing machine. This press sheet 1 has a non-printable margin area 11 on the edge, shown hatched in FIG. 1. On the press sheet 1 are provided a plurality of double slot perforation lines 2, 3, 6, which extend perpendicular to each other and intersect each other. In particular the first double slot perforation lines 2 are provided, which extend in lengthwise direction LR of the press sheet 1, and second double slot perforation lines 3, which are oriented in crosswise direction QR of the press sheet 1. The intersecting first and second double slot perforation lines 2, 3 divide the press sheet 1 into a plurality of sheet sections 10, which after further processing of the press sheet 1 respectively form single pages of a book block. This makes it possible to produce multiple pages of a book block from one single press sheet 1 by folding along at least one part of the first and/or second double slot perforation lines 2, 3. FIG. 1 shows a plurality of double slot perforation lines 2, 3, 6 to produce printed products of different formats by means of one press sheet 1 of a specific format, for example the format DIN A5++. It goes without saying that for execution of the invention it is sufficient if only part of the shown double slot perforation lines 2, 3, 6 are produced in the press sheet 1.

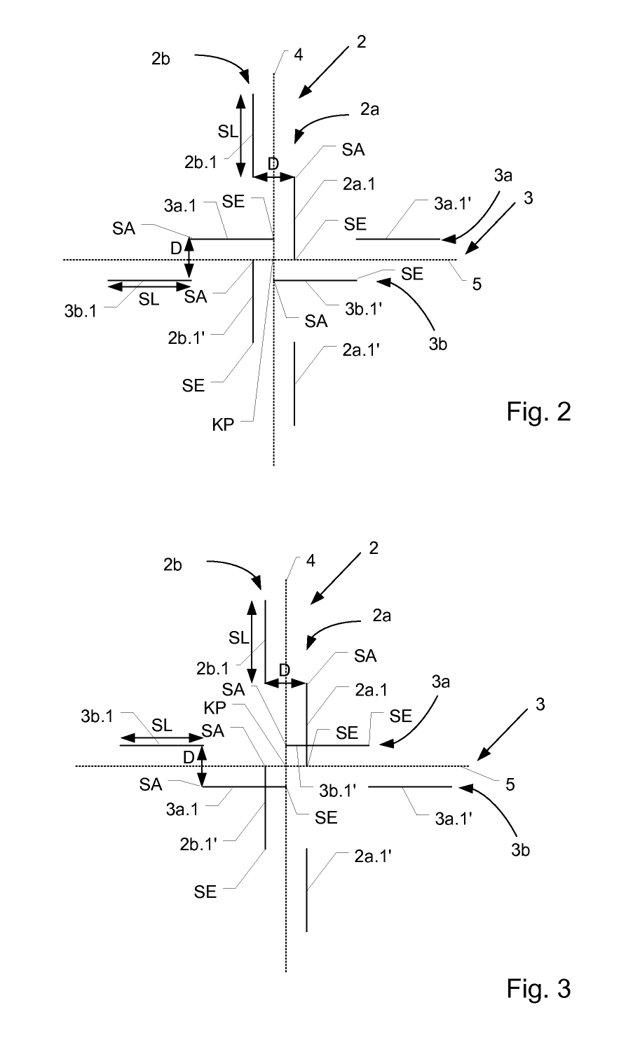

FIGS. 2 and 3 show the arrangement according to the invention of the intersecting first and second double slot perforation lines 2, 3. The double slot perforation lines 2, 3 consist respectively of one first and second perforation line 2a, 2b, 3a, 3b, each perforation line 2a, 2b, 3a, 3b respectively being formed by a plurality of straight slots 2a.1, 2a.1′, 2b.1, 2b.1′, 3a.1, 3a.1′, 3b.1, 3b.1′. The slots 2a.1, 2a.1′, 2b.1, 2b.1′, 3a.1, 3a.1′, 3b.1, 3b.1′ respectively have a slot length SL, the slot lengths SL of all slots 2a.1, 2a.1′, 2b.1, 2b.1′, 3a.1, 3a.1′, 3b.1, 3b.1′ being the same. The slots 2a.1, 2a.1′, 2b.1, 2b.1′, 3a.1, 3a.1′, 3b.1, 3b.1′ of the respective perforation lines 2a, 2b, 3a, 3b are respectively at a distance from each other, namely such that the distance between the slot end SE of one slot 2a.1, 2b.1, 3a.1, 3b.1 to the slot beginning SA of the following slot 2a.1′, 2b.1′, 3a.1′, 3b.1′ in the respective perforation line 2a, 2b, 3a, 3b is exactly one slot length SL. The slots 2a.1, 2a.1′, 2b.1, 2b.1′, 3a.1, 3a.1′, 3b.1, 3b.1′ of the perforation lines 2a, 2b; 3a, 3b forming the double slot perforation lines 2, 3 are arranged in relation to each other so that the slots 2a.1, 2a.1; 3a.1, 3a.1′ of the first perforation lines 2a, 3a are arranged staggered to the slots 2b.1, 2b.1; 3b.1, 3b.1′ of the second perforation line 2b, 3b.

The perforation lines 2a, 2b; 3a, 3b are furthermore arranged parallel and at a distance to each other, the distance being D. Further, the double slot perforation lines 2, 3 respectively include a folding line 4, 5, the folding lines 4, 5 respectively extending parallel to the perforation lines 2a, 2b, 3a, 3b of their double slot perforation lines 2, 3. The folding lines 4, 5 are arranged in the middle between the perforation lines 2a, 2b; 3a, 3b and therefore form the middle longitudinal axis of the respective double slot perforation lines 2, 3.

In order to simultaneously produce from a single press sheet 1 a plurality of sheet sections 10, 10′ defined by double slot perforation lines for producing a high strength adhesive bond, according to the invention at least one first double slot perforation line 2 is produced on the press sheet 1 in the lengthwise direction LR of the press sheet 1 and at least one second double slot perforation line 3 is produced in the crosswise direction QR of the press sheet 1.

The alignment of the intersecting double slot perforation lines 2, 3 according to the invention takes place such that the fold line 4 of the first double slot perforation line 2 extends between the slot end SE of one first slot 3a.1 of the first perforation line 3a and the slot beginning SA of the second slot 3b.1′ of the second perforation line 3b of the second double slot perforation line 3 which (second slot) directly follows the first slot 3a.1

Preferably, the alignment of the first and second double slot perforation lines 2, 3 takes place such that the fold line 5 of the second double slot perforation line 3 extends between the slot end SE of one first slot 2a.1 of the first perforation line 2a and the slot beginning SA of the second slot 2b.1′ of the second perforation line 2b of the first double slot perforation line 2 which (second slot) directly follows the first slot 2a.1. The arrangement of the intersecting double slot perforation lines 2, 3 according to the invention offers the decisive advantage that also after folding of the press sheet 1 on the folding lines 4, 5, the regular, meandering course of the double slot perforation lines 2, 3 is retained. It is further achieved that upon arranging a plurality of superposed fold sheets 7, the open spaces 12 and the tab-shaped protrusions 13 of the superposed sheet sections 10, 10′ resulting from the folding respectively have a longitudinal offset by one slot length SL, so that adhesive joints are created through the open spaces 12 of one sheet section 10, 10′, connecting two sheet sections 10, 10′ not directly adjacent to each other. The same applies to the tab-shaped protrusions 13. Their position also alternates in the intersection of the double slot perforation lines 2, 3 according to the invention in the consecutive sheet sections 10, 10′, so that the tab-shaped protrusions 13 of each second sheet section 10, 10′ of the superposed fold sheets 7 are arranged at the same positions respectively. The glue applied to the tab-shaped protrusions 13 therefore respectively bonds one sheet section 10, 10′ with the respective second following sheet sections 10, 10′.

FIG. 3 shows a further arrangement of the intersecting double slot perforation lines 2, 3. The difference from the arrangement according to FIG. 2 is that the double slot perforation line 3 is offset by one slot length SL with respect to the double slot perforation line 2. Also in this exemplary embodiment double slot perforation lines 2, 3 are aligned such that the fold line 4 of the one double slot perforation line 2 extends between the slot end SE of one first slot 3a.1 of the first perforation line 3a and the slot beginning SA of the second slot 3b.1′ of the second perforation line 3b of the second double slot perforation line 3 which (second slot) directly follows the first slot 3a.1. For the arrangement of the double slot perforation line 2 in relation to the fold line 5, the descriptions with respect to FIG. 2 apply accordingly. Especially in the case of an embodiment of the double slot perforation lines 2, 3 such that the slot length SL is greater than the distance D of the perforation lines 2a, 2b and 3a, 3b extending parallel to each other, there are no interfering effects by the intersections of the slots 2a.1, 3b.1′ and the slots 2b.1′ and 3a.1. Especially preferably the distance D of the perforation lines 2a, 2b, 3a, 3b extending parallel to each other is between 0.3 mm and 0.4 mm, the slot length SL being between 3 and 5 mm.

In a particularly preferred exemplary embodiment the first and second double slot perforation lines 2, 3 are arranged in relation to each other so that the point of intersection KP of the first and second folding line 4, 5 respectively lies on the connecting lines between the slot end SE of one first slot 2a.1, 3a.1 of the first perforation line 2a, 3a and the slot beginning SA of the second slot 2b.1′, 3b.1′ of the second perforation line 2b, 3b which (second slot) directly follows the first slot 2a.1, 3a.1. The intersection point KP is therefore in the center between the slot ends SE and slot beginnings SA of the slots 2a.1, 3a.1, 2b.1′, 3b.1′ adjoining the intersection point KP.

As can be seen especially in FIG. 1, the parallel double slot perforation lines 2, 3, 6 are arranged in phase to each other, i.e. they are not offset in the press sheet 1, so that the respectively corresponding slots 2a.1, 2a.1′, 2b.1, 2b.1′, 3a.1, 3a.1′, 3b.1, 3b.1′ are arranged at the same height on the press sheet 1.

As shown in FIG. 1, preferably a plurality of first double slot perforation lines 2 extending parallel to each other in lengthwise direction of the press sheet 1 and a plurality of second double slot perforation lines 3, 6 extending perpendicular to the first double slot perforation lines 2 are provided on the press sheet 1. In the depicted exemplary embodiment the first double slot perforation lines 2 have the same distance to each other respectively. The double slot perforation lines 3 likewise have the same distance to each other, and a further double slot perforation line 6 is provided at least to a partial extent between two consecutive double slot perforation lines 3, centered between the latter. Preferably the distances of the first double slot perforation lines 2 is equal or essentially equal to the distance of two consecutive second double slot perforation lines 3. Due to the double slot perforation lines 6 provided between two second double slot perforation lines 3 it is possible to produce rectangular sheet sections 10, 10′ that have a height-to-width ratio of 2/3 or essentially 2/3 in relation to each other. The double slot perforation lines 2, 3, 6 are produced in the press sheet 1 using slot perforating tools known in the art, in particular perforating discs.

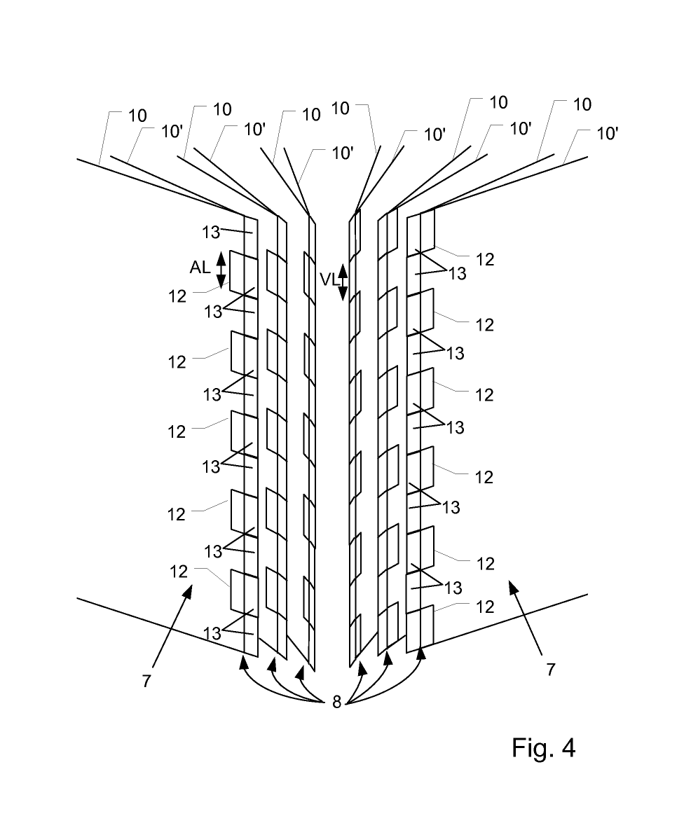

After providing the double slot perforation lines 2, 3, 6 the press sheet 1 is folded on at least one double slot perforation line 2, 3, 6. To illustrate the embodiment of the adhesive bond areas, FIG. 4 shows a plurality of fold sheets 7 arranged next to each other that were folded for example on a double slot perforation line 3. The fold sheets 7 consist respectively in the exemplary embodiment of two sheet sections 10, 10′ connected with each other at the folding position 8. On the folding positions 8 of the fold sheets 7 the double slot perforation forms open spaces 12 and tab-shaped protrusions 13, the open spaces 12 being produced in the areas of the sheet sections 10, 10′ adjoining the folding position 8 and the protrusions 13 protruding from the folding position 8 into the area facing away from the sheet sections 10, 10′. Due to the embodiment of the double slot perforation lines 2, 3, 6 described above the open spaces 12 of a sheet section 10 have an open space length AL equal to the slot length SL and are at a distance to each other of one slot length SL. The open space width and the protrusion width are respectively half the distance of the perforation lines 2a, 2b, 3a, 3b extending parallel to each other. The open spaces 12 of the sheet section 10′ connected to said sheet section 10 are dimensioned in the same way and likewise have a distance to each other of one slot length SL, but are respectively arranged staggered to the open spaces 12 of the sheet section 10. The tab-shaped protrusions 13 are arranged staggered to the open spaces 12 of the sheet section 10, 10′ from which they protrude. They have a protrusion length VL likewise equal to the slot length SL, so that also the tab-shaped protrusions 13 are respectively at a distance of one slot length SL to each other. The protrusions 13 of the sheet sections 10, 10′ connected with each other at the fold position 8 are likewise arranged staggered relative to each other. In the stacked arrangement of the fold sheets 7 such that the fold positions are congruently superposed the open spaces 12 and the tab-shaped protrusions 13 of the consecutive sheet sections 10, 10′ are provided alternating at different heights on the fold edge 8 respectively. This makes it possible by means of application of glue to connect the sheet sections 10 and the sheet sections 10′ with each other, i.e. one sheet section 10, 10′ is connected with its second following sheet sections 10, 10′, namely through the open spaces 12 and by the tab-shaped protrusions 13, which are arranged respectively at the same height on the sheet sections 10 and the sheet sections 10′.

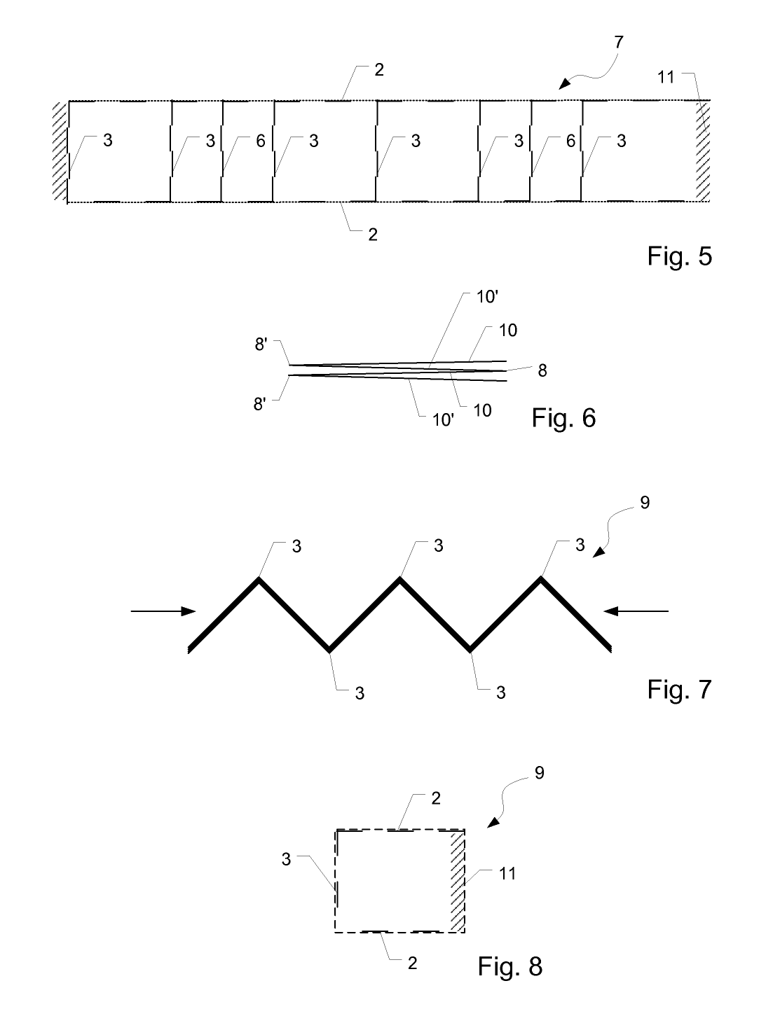

FIGS. 5 and 6 show a further fold sheet 7 that likewise comprises the above-described alternating arrangement of open spaces 12 and tab-shaped protrusions 13 with respect to the consecutive sheet sections 10, 10′. The depicted fold sheet 7 is produced for example by folding the press sheet 1 from FIG. 1 on the double slot perforation lines 2 alternately in different folding directions, so that a zig-zag fold sheet is produced.

The further processing of the fold sheet 7 can take place in at least two different ways. A plurality of press sheets 1 can be successively transformed into a zig-zag fold sheet 7 in the manner described above. They are then arranged on top of each other so that the fold edges 8, 8′ are respectively congruently superposed. Afterwards the fold sheets 7 are glued together in a fold area in which for example the fold edges 8 and 8′ are superposed. The alternating arrangement of open spaces 12 and the tab-shaped protrusions 13 according to FIG. 4 is formed on the fold edges 8, 8′, so that the zig-zag folding reduces the amount of work required to assemble the fold sheets, since a zig-zag fold sheet preferably comprises a plurality of connected sheet sections 10, 10′.

The preliminary product thus produced can then be cut using a three-side cut, i.e. by cutting for example along the double slot perforation lines 3, 6 and the side opposite the adhesive bond area, so that a plurality of book blocks is produced simultaneously.

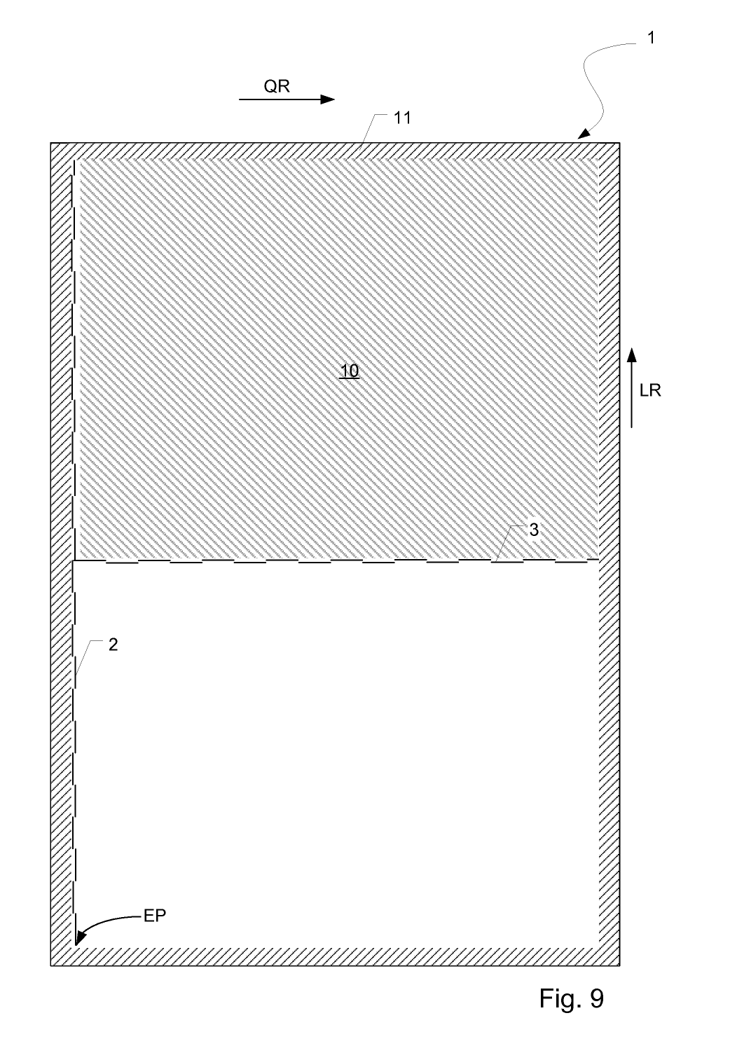

The fold sheet 7 shown in FIGS. 5 and 6 can however also be transformed into a multiple fold sheet 9 by further zig-zag folding on the consecutive double slot perforation lines 3, 6, as schematically depicted in FIG. 7. This multiple fold sheet 9 shown in FIG. 8 can for example now receive an application of glue on one side. The other sides can be cut by three-side cutting, to produce a book block consisting of multiple pages. This type of processing is advantageous especially for producing book blocks with a small number of pages.

To compensate for fluctuations in the paper format, preferably the double slot perforation lines 2, 3, 6 are arranged in relation to a corner point EP, which is either the corner point of the press sheet 1 itself or the corner point of the printable area of the press sheet 1. This can be achieved t regardless of the actual paper format, all double slot perforation lines 2, 3, 6 preferably always have the desired distance relative to each other and no deviations occur between a plurality of fold sheets 7 processed together.

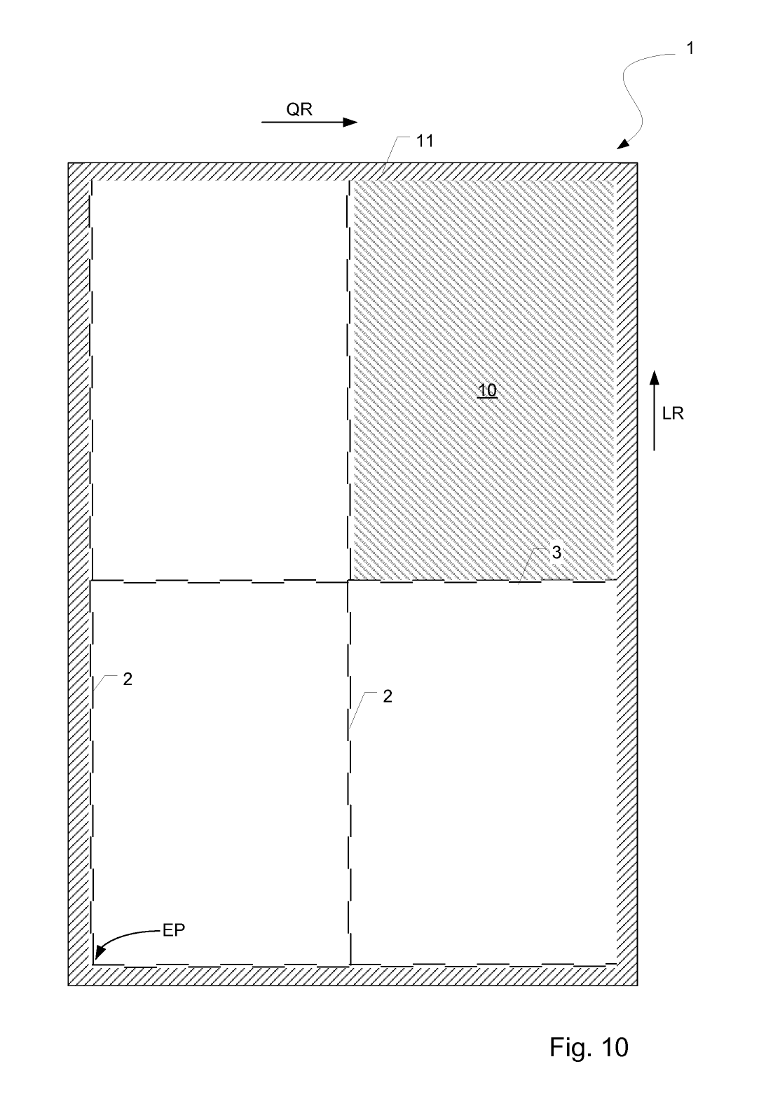

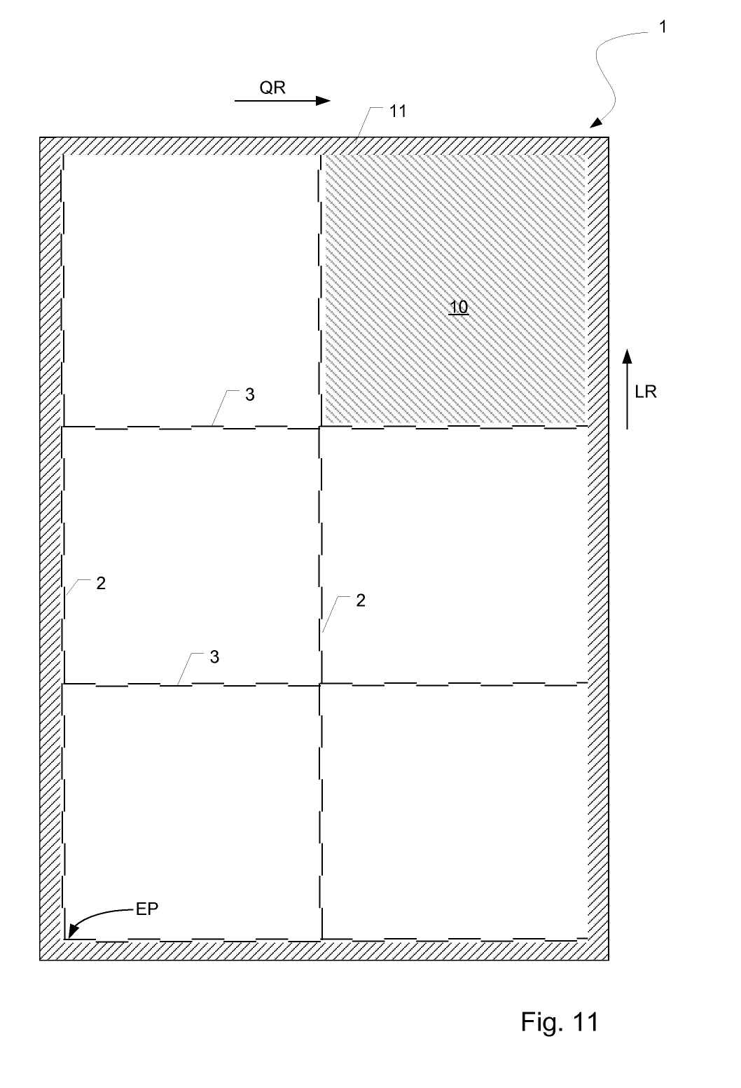

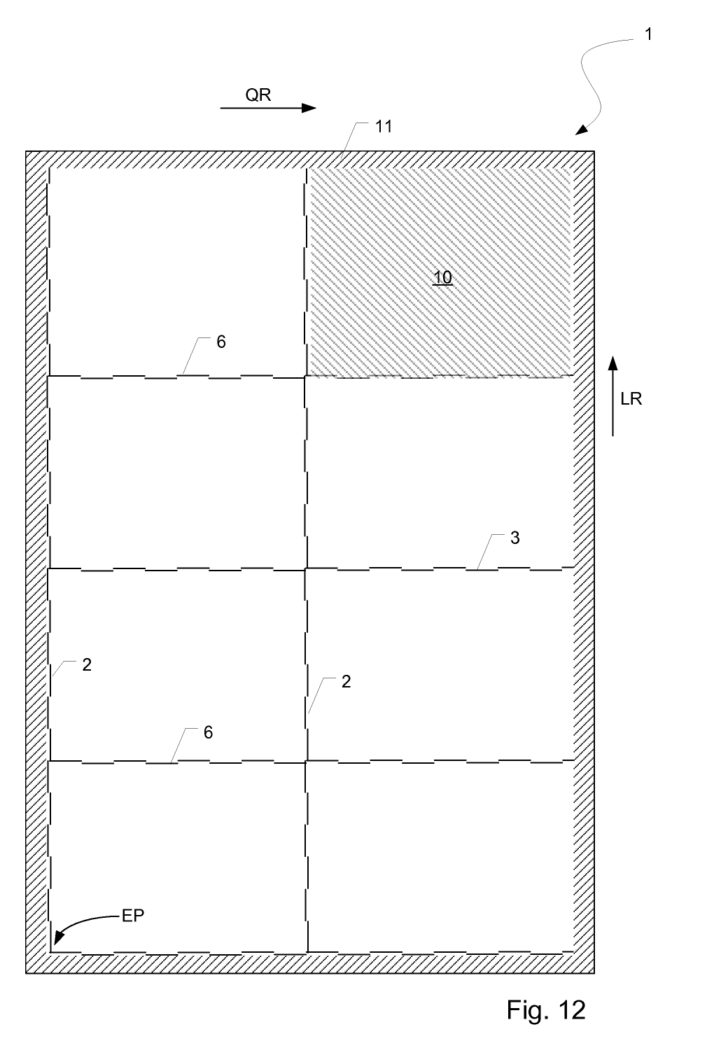

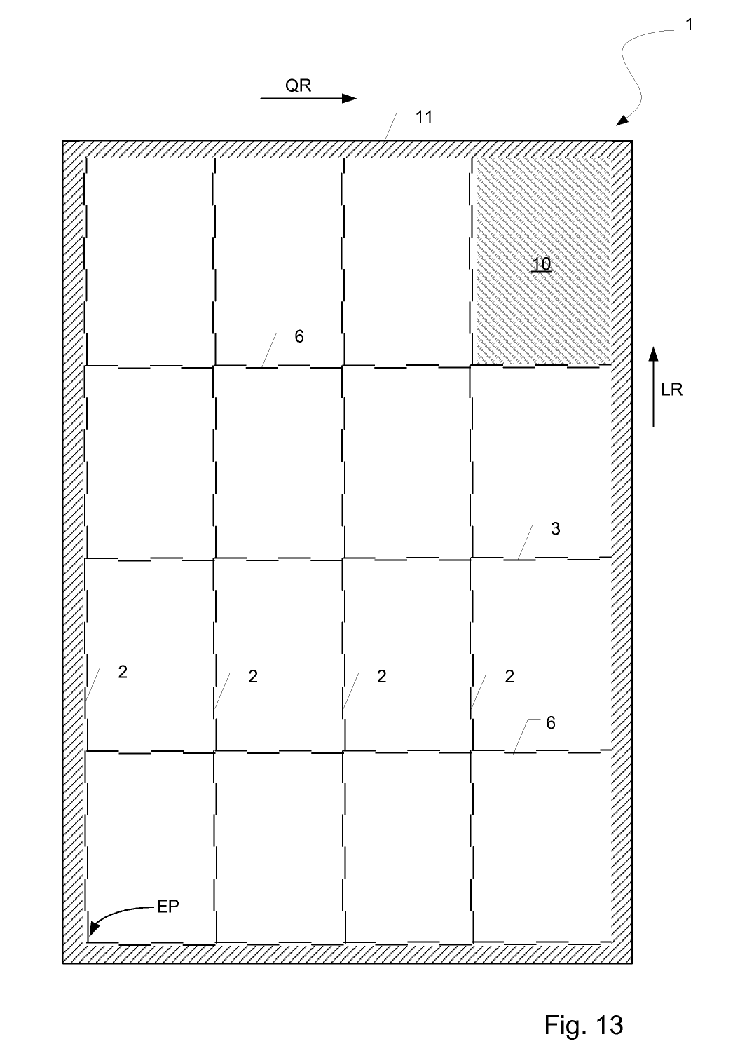

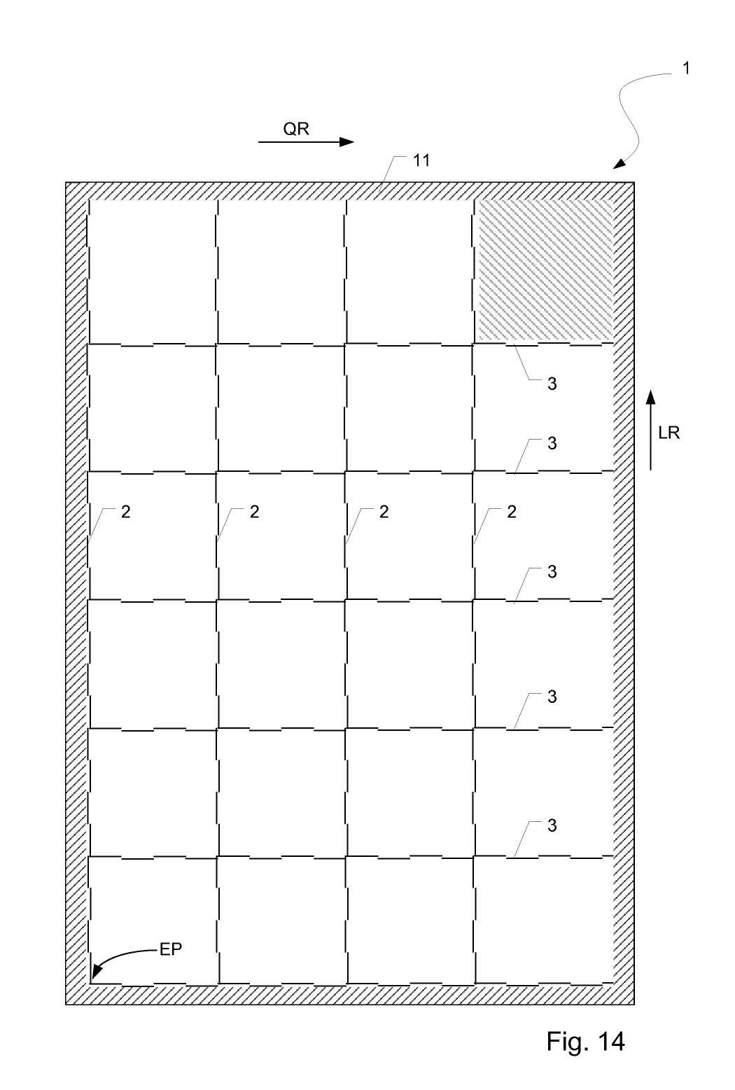

FIGS. 9 through 14 respectively show press sheets 1 in which different double slot perforation lines 2, 3, 6 are produced in order to produce sheet sections 10, 10′ of different formats from the press sheet 1. By only partially producing double slot perforation lines 2, 3, 6 in the press sheet 1, one press sheet 1, which for example has the format DIN A3++, can be used to produce sheet sections 10, 10′ with the square format 68 mm×68 mm (FIG. 14), the format DIN A7 (FIG. 13), the format DIN A6 (FIG. 12), the square format 145 mm×145 mm (FIG. 11), the format DIN A5 (FIG. 10) and the format DIN A4 (FIG. 9).

In the following the further processing of the press sheets 1 provided with the double slot perforation lines 2, 3, 6 is described based on two exemplary formats. For the production of a book block in format DIN A4 portrait format, the press sheet 1 is folded on the middle double slot perforation line 3 according to FIG. 9. The fold sheet 7 thus produced is assembled with other fold sheets 7 of the same format, namely so that the fold edges 8 produced by folding along the double slot perforation line 3 are congruently superposed. The fold sheets 7 are then connected with each other by the application of glue in the area of the fold edges 8.

To produce a book block in DIN A4 landscape format, the edge area 11 protruding to the side from the double slot perforation line 2 is separated and the press sheet 1 is folded along the double slot perforation line 3. Afterwards a plurality of such fold sheets 7 can be superposed, in which process the cutting line produced by means of the double slot perforation line 2 serves as a gluing position for the superposed fold sheets 7. Afterwards, the single sheet sections of the fold sheets 7 are separated from each other and cut to size by a three-side cut.

To produce a book block in DIN A5 portrait format, the press sheet 1 is first provided with a double slot perforation line 2 that extends in the middle in lengthwise direction LR of the press sheet 1. Afterwards the press sheet 1 is folded along this double slot perforation line 2. The fold sheet 7 thus produced is assembled with other fold sheets 7 and glue is applied to the fold edges 8. The preliminary product thus produced is then separated at the double slot perforation lines 3 and cut in a three-side cut.

To produce a book block in DIN A5 landscape format, the processing takes place in the reverse sequence, i.e. the press sheet 1 is first folded on the double slot perforation line 3 provided in the press sheet 1 in crosswise direction QR. The fold sheets 7 thus produced are then arranged on top of each other, namely so that the fold edges 8 are congruently superposed. Then glue is applied in the area of the fold edges 8. After gluing, the preliminary product thus produced is separated along the double slot perforation line 2 and the separated book blocks are cut in a three-side cut.

Alternatively it is possible to produce a multiple fold sheet 9, so that the press sheet 1 is first folded, for example, along the double slot perforation line 2 and then folded on the double slot perforation line 3. The multiple fold sheet 9 thus produced comprises four sheet sections 10, 10′ that can be printed on both sides and therefore eight pages.

The processing of the press sheets 1 for producing book blocks in the other formats takes place in an analogous manner recognizable to persons skilled in the art. In this respect reference is made to the foregoing descriptions.

The invention was described above based on an exemplary embodiment. It is to be understood that numerous variations and modifications of the invention are possible without abandoning the underlying inventive concept.

### REFERENCE LIST

1 press sheet
2 double slot perforation line
2a first perforation line
2a.1, 2a.1′ slot
2b second perforation line
2b.1, 2b.1′ slot
3 double slot perforation line
3a first perforation line
3a.1, 3a.1′ slot
3b second perforation line
3b.1, 3b.1′ slot
4 first folding line
5 second folding line
6 double slot perforation line
7 fold sheet
8, 8′ fold edge
9 multiple fold sheet
10, 10′ sheet section
11 margin area
12 open space
13 protrusion
AL length of open space
D distance
EP corner point
VL protrusion length
LR lengthwise direction
QR crosswise direction
SA slot beginning
SE slot end
SL slot length

What is claimed is:

1. A method for processing press sheet for book blocks, comprising producing on a press sheet at least one first double slot perforation line and at least one second double slot perforation line each comprising one first and second perforation line formed from a plurality of slots of the same slot length, wherein the slots of the first and second perforation lines of each of the first and second double slot perforation lines are produced in the press sheet in such a manner that two consecutive slots of each first and second perforation line have a distance of one slot length from each other, that the first and second perforation line are arranged in relation to each other so that the first and second perforation lines extend in parallel and spaced relation to each other and have a longitudinal offset of one slot length to each other, so that the slots of the first perforation line are arranged staggered to the slots of the second perforation line and that a folding line is formed between the first and second perforation line, wherein the at least one first double slot perforation line including a first folding line extends in a lengthwise direction of the press sheet and the at least one second double perforation line including a second folding line extends in a crosswise direction of the press sheet and that the alignment of the first and second double slot perforation lines in relation to each other is such that the first folding line of the first double slot perforation line extends between the slot end of a first slot of the first perforation line of the second double slot perforation line and the slot beginning of a second slot of the second perforation line of the second double slot perforation line, wherein the second slot directly follows the first slot.

2. The method according to claim 1, further comprising arranging the first and second double slot perforation lines in relation to each other so that the point of intersection of the first and second folding lines lies on the connecting lines between the slot end of one first slot of the first perforation line and the slot beginning of the second slot of the second perforation line wherein the second slot directly follows the first slot.

3. A method for processing press sheets for book blocks, comprising producing on a press sheet a plurality of double slot perforation lines each comprising first and second perforation lines formed from a plurality of slots of the same slot length, wherein the slots of the first and second perforation line respectively are produced in the press sheet such that two consecutive slots of each first and second perforation line have a distance of one slot length from each other, that the first and second perforation lines are arranged in relation to each other so that the first and second perforation lines extend in parallel and spaced relation to each other and have a longitudinal offset of one slot length to each other, so that the slots of the first perforation line are arranged staggered to the slots of the second perforation line and that a first folding line is formed between the first and second perforation lines, wherein the plurality of double slot perforation lines extend in parallel and spaced relation to each other on the press sheet and are arranged not offset to each other, so that the respectively corresponding slots are arranged at the same height on the press sheet.

4. The method according to claim 3, wherein the step of producing a plurality of double slot perforation lines on the press sheet comprises producing at least two first double slot perforation lines extending in parallel and spaced relation to each other and each first double slot perforation line includes one first folding line extending in a lengthwise direction of the press sheet and at least one second double slot perforation line including a second folding line is produced in a crosswise direction of the press sheet and the alignment of the first and second double slot perforation lines in relation to each other is such that the folding lines of the first double slot perforation lines extend between the slot end of one first slot of the first perforation line and the slot beginning of the second slot of the second perforation line of the second double slot perforation line wherein the second slot directly follows the first slot.

5. The method according to claim 3, further comprising arranging the first and second double slot perforation lines in relation to each other so that the points of intersection of the first and second folding lines respectively lie on the connecting lines between the slot end of one first slot of the first perforation line and the slot beginning of the second slot of the second perforation line wherein the second slot directly follows the first slot.

6. The method according to claim 1 wherein the press sheet is rectangular and the method further comprises dividing the press sheet by the first and second double slot perforation lines into a plurality of rectangular or square sheet sections.

7. The method according to claim 1 further comprising producing a plurality of first double slot perforation lines extend in parallel and spaced relation to each other on the press sheet in a lengthwise direction thereof and/or a plurality of second double slot perforation lines extend in parallel and spaced relation to each other on the press sheet in crosswise direction thereof.

8. The method according to claim 1 further comprising arranging all double slot perforation lines extending in parallel and spaced relation to each other not offset to each other, so that the respectively corresponding slots are arranged at the same height on the press sheet.

9. The method according to claim 1 further comprising spacing two consecutive second double slot perforation lines to have the same distance between each other and producing on the press sheet a third double slot perforation line that extends parallel to the second double slot perforation lines and arranging the third double slot perforation line in the center between two consecutive second double slot perforation lines.

10. The method according to claim 1 further comprising the step of folding the press sheet on at least one of a first, second or third double slot perforation line to form at least one fold sheet comprising at least one fold edge.

11. The method according to claim 1 further comprising the step of folding the press sheet on consecutive, parallel first, second or third double slot perforation lines alternating in different folding directions to produce a zig-zag fold sheet.

12. The method according to claim 10 further comprising the steps of arranging a plurality of fold sheets on top of each other so that the fold edges are superposed and gluing the fold sheets together in a folding area in which a plurality of fold edges are congruently superposed.

13. The method according to claim 10 further comprising the step of folding the press sheet to produce a fold sheet having an edge length that is a multiple of the edge length of the book block to be produced.

14. The method according to claim 12 further comprising the steps of making cuts to the fold sheets extending perpendicular to the fold edges.

15. The method according to claim 10 further comprising the step of folding the fold sheet on at least one additional second double slot perforation lines extending perpendicular to the fold edge to form a multiple fold sheet.

16. The method according to claim 15, further comprising the step of gluing the multiple fold sheet in a folding area in which a plurality of fold edges are aligned on top of each other and the at least one additional fold edge extends perpendicular to the folding area is separated by side cutting.

17. The method according to claim 15 characterized in that the multiple fold sheet essentially has the format of the book block to be produced.

18. The method according to claim 1 comprising arranging all first, second and third double slot perforation lines in relation to a corner point of the press sheet or in relation to a corner point of the printable area of the press sheet.

19. The method according to claim 10 characterized in that the press sheet used is printed on the front and back and sheet sections separated from each other by the first, second or third double slot perforation lines respectively constitute pages of the book block.
